(19) United States
(12) Patent Application Publication
(10) Pub. No.: US 2002/0152469 A1
(43) Pub. Date: Oct. 17, 2002

(54) System to increase the capacity of the satellite intermediate frequency signal distribution networks

(76) Inventors: Mor Allon, Mevaseret Zion (IL); Francisco Javier Lopez, San Sebastian (ES)

Correspondence Address: BIERMAN MUSERLIAN AND LUCAS, 600 THIRD AVENUE, NEW YORK, NY, 10016

(21) Appl. No.: 09/835,736

(22) Filed: Apr. 16, 2001

(51) Int. Cl. H04N 7/20

(52) U.S. Cl. 725/67; 725/68

(57) ABSTRACT

System to increase the capacity of the satellite intermediate frequency signal distribution networks, of the kind that are comprised of a header, which receives the channels (CH) with the original signals in QPSK format, it processes them and sends them to a converter, which sends its output signals to the user's receiver, characterised because in the header at least some of the channels (CHP) are processed at QAM format and because the converter converts the QAM modulation format into QPSK modulation format.

For application in digital television.

The proliferation of the number of digital television operators with the subsequent increase in offer of available channels represents a new scenario for which the collective antenna networks are not conceived.

As the use of Anglo-Saxon nomenclature is usually and internationally used in this field and by any expert or scholar of the subject, it will also be used in this procedure, mainly to identify concepts by their initials such as, for example, in the modulation formats QAM (Quadrature Amplitude Modulation) and QPSK (Quadrature Phase Shift Keying) will be used.

In effect, even considering the considerable increase in capacity represented by the compliance with the new legislation related to the Common Telecommunications infrastructure, the constant increase in the number of available satellites means that the available bandwidth to disseminate the digital television services in QPSK modular format offered through the aforementioned satellites is insufficient. To cope with this situation different solutions have appeared although they can all be summarised in two classes:

First solution based on conversion intermediate frequency (FIS) to intermediate frequency (FIS). In this case, the signal distribution system is comprised of a header comprised of FIS/FIS processors, a distribution network and a user's receiver.

This solution works adequately but prevents processing all the channels, as the original bandwidth is greater than that available in the distribution network, given both the number of channels and the spectral width of each one on being a QPSK modulation format.

The second solution is a system based on conversion from FIS to UHF. In this system, the header is comprised of a partial band converter, which transfers some of the channels as a group, to the part of the band included between 450 and 860 MHz.

The channels thus converted, are transported by the network to the subscriber's home, where a reverse group converter returns the signals to the spectrum of the FIS band where they can be processed by the user's receiver.

This system, like the previous one, works adequately but lacks capacity. In effect, one the one hand, the bandwidth used is 410 MHZ, which together with the fact that each channel occupies 30 MHz, only permits the transportation of 13 channels.

The solution given by the requesting party is a system to increase the capacity of the satellite intermediate frequency distribution networks, comprised of a header integrated by a plurality of Transparent Digital Transmodulators (TDT1, TDT2, . . . TDTn), a signal adder SM1, the actual distribution network RD1, a QAM-QPSK user converter CU1 and a user receiver IRD1, which is only able to receive signals in QPSK format inside a certain part of the band called satellite intermediate frequency (FIS) (910-2400 MHz).

The header processes part of the channels CH1, CHs . . . Chn present in its input, converting them from the original QPSK format to QAM, which has much greater spectral efficiency.

These signals are transported by the D1 distribution network to the converter CU1, where they are reconverted to the original modulation format QPSK, so that they can be processed by the receiver IRD1.

In order to understand the object of this invention better, a preferential way of practical execution is illustrated on the drawings, subject to accessory changes that take nothing away from its basis

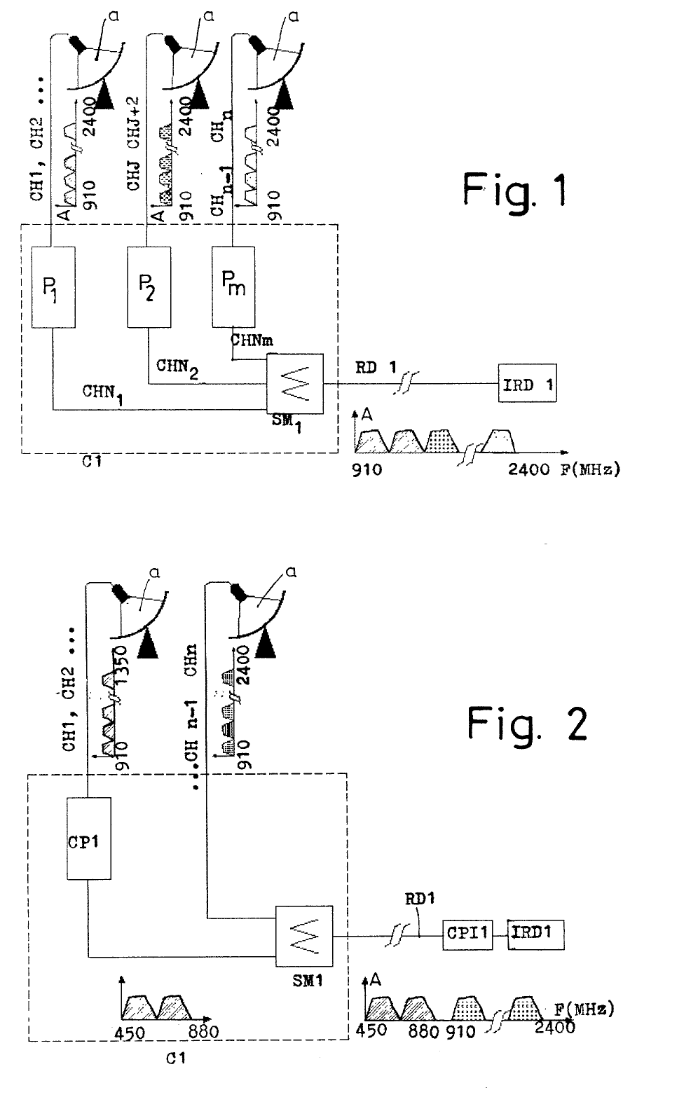

FIG. 1 is an illustration by way of diagram of a first known solution

FIG. 2 is an illustration by way of diagram of a second known solution.

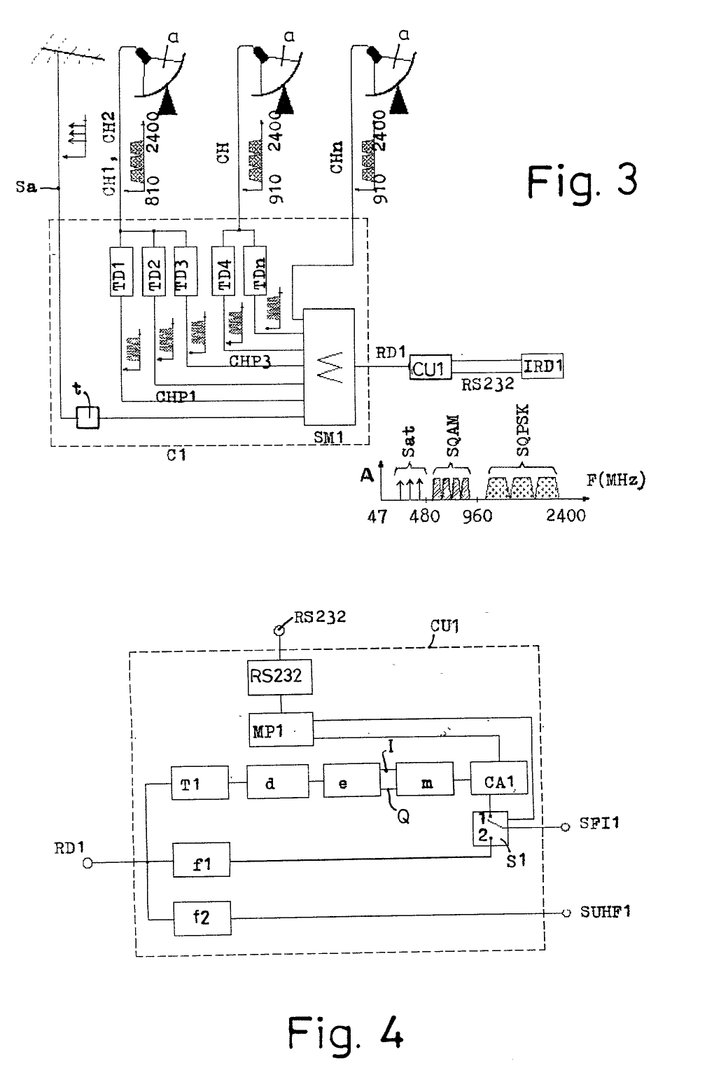

FIG. 3 is an illustration by way of diagram of a practical execution of the solution targeted by the invention.

In FIGS. 1, 2 and 3 the input signals and the output signals of the header (C1) are also represented in Cartesian axes with amplitudes (A) in ordinates and frequencies (F) in abscises.

FIG. 4 is a block diagram of the user converter (CU) of FIG. 3.

Below a non-limiting example of a practical execution is described of this invention.

In the solution based on conversion intermediate frequency (FIS) to intermediate frequency (FIS) (FIG. 1) the signal distribution system is comprised of a header (C1) with FIS/FIS processors. (P.1, P2 . . . Pm), a signal adder (SM1) a distribution network (RD1) and a user receiver (IRD1).

Of the plurality of channels (CH1, CH2 . . . CHn) present at the output of the modulated capturing systems (a) in QPSK format, a larger number will coincide in frequency due to coming from different satellites. Some of them are introduced into the header (C1), which provides other different frequencies (CHN1, CHN2 . . . CHNm) as an output signal, where m is always less than n, and which occupies the whole capacity of the distribution network RD1.

This solution works adequately but prevents the processing of all the channels, due to the fact that the original bandwidth is greater than that available in the RD1 network, given both the number of channels and the spectral width of each one on being a QPSK modulation format.

In the system based on the conversion from FIS to UHF (FIG. 2) the header (C1) is comprised of a partial band converter (CP1), which transfers some of the channels (CH1, CH2 . . . CHn) as a group, to the part of the band included between 450 and 860 MHz.

The channels thus converted, are transported by the RD1 network to the subscriber's home, where a reverse group converter (CPI1) returns the signals to the FIS band spectrum where they can be processed by the user receiver (IRD1).

This system, like the previous one, works adequately but lacks capacity, In effect, on the one hand, the bandwidth used is 410 MHz, which, together with the fact that each channel occupies 30 MHz, only permits the transportation of 13 channels.

The system targeted by the invention and shown in diagram form in FIG. 3, solves the capacity problem by combining more efficient modulation formats with a user converter, the heart of the system, able to regenerate the original format QPSK of the signal of origin (channels CH).

Thus, a system according to the new structure proposed, would be comprised of a header (C1), with the following elements:

a) Transparent Digital Transmodulators (TDTs), able to transform QPSK modulation formats to QAM without altering the original content of the information transported.

b) A signal adder SM1, where the channels processed by the TDTs, CFP1 . . . CHPj are added, which apart from having the QAM modulation format have been transferred to the frequency margin included between 450 and 860 MHz.

c) An analogue signal (Sa) processing system (t) with terrestrial diffusion.

The signal/channel group from the signal adder (SM1), which are:

Analogue signals (Sat)

Processed channels (CHP) with QAM format (SQAM)

Non-processed channels (CH) with QPSK format (SQPSK) is transported by the distribution network RD1 to the subscriber's home. There, they are processed by the converter CU1 which provides, on the one hand, the frequency spectrum included between 47 and 450 MHz where the terrestrial diffusion analogue channels are situated; on the other hand, the original channels CH (not processed) and the result of the channel conversion CHP to its original format QPSK and to a frequency margin included within the FIS band. The signals thus generated are injected to the user receiver IRD1.

As the nucleus of the system is based on the original user converter (CU1) QAM-QPSK, its composition is described in detail.

FIG. 4 shows a preferential execution of this function. Here, the UHF tuner (T1), selects the UHF frequency margin where the CHP processed channels to be processed are found and converts them into a lower frequency which can be treated by the demodulator (d) of QAM DQAM1. At the output, the original basic band signal is obtained, which is processed by the encoder QPSK (e). This supplies the necessary I and O signals for the later modulator IQ (m) that generates a radio frequency signal in a lower value frequency modulated in QPSK format. This signal is delivered to the agile converter CA1, which transfers it to the frequency margin included within the FIS. Its output supplies the selector switch S1, which selects, by means of the control microprocessor MP1, the origin of signals to be presented in the output SFI1. In effect, S1 in position 1, selects the signals in QPSK format, which originally belonged to the CHP processed channels. On the other hand, in position 2, it selects the original non-processed signals CH. It has an additional filter (f1).

In addition, and thanks to the presence of the FUHF filter (f2), there is an auxiliary output SUHF1 where the terrestrial diffusion analogue signals are available.

The control microprocessor MP1 is governed in turn by the user receiver IRD1 through the communications port (RS232. This control is necessary and fundamental within the system, as, finally and in selector switch S1, signals are available in the same frequency band FIS. Therefore the user receiver IRD1, in response to a request by the user, selects a CHP processed channel through the tuner (T1) and the output frequency of the reconverted channel by means of the agile converter and selector switch (C) (S1), or any of the CH unprocessed channels in original format QPSK through the selector switch (S1).

1. System to increase the capacity of the satellite intermediate frequency signal distribution networks, of the type that are comprised of a header which receives the channels (CH) with the original signals in QPSK format, processes them and sends them to a converter which sends its output signals to the user's receiver, characterised because in the header at least some of the channels (CHP) are processed at QAM form and because the converter converts the QAM modulation format into QPSK modulation format.

2. System to increase the capacity of the satellite intermediate frequency signals distribution networks, according to previous claim, characterised because the converter (CU1) has a tuner (T1), which selects the UHF frequency margin where the processor channels with QAM format (CHP) to be processed are found, and converts them into a lower frequency, which can be treated by a QAM DQAM1 demodulator (d), obtaining at the output the original basic band signal, which is processed by the encoder (e) QPSK, which supplies the I and Q signals necessary for a later modulator IQ m), which generates a radiofrequency signal in a low value frequency modulated in QPSK format, which is delivered to an agile converter (CA1), which transfers it to the frequency margin included within the FIS and whose output supplies a selector switch S1 which selects, by means of a control microprocessor (MP1), the origin of signals to be presented at the output (SFI1) of the selector switch (S1) which in one position (1), selects the signals in QPSK format, which originally belonged to the processed channels (CHP) and in another position (2), selects the original signal (CH) not processed in QAM format.

3. System to increase the capacity of the satellite intermediate frequency signal distribution network, according to previous claims, characterised because the header has transparent digital transmodulators (TDT) to transform the QPSK format of some of the original channels (CH) into QAM modulation format situated in another position of the spectrum for the processed channels (CHP).

4. System to increase the capacity of the satellite intermediate frequency signal distribution networks, according to previous claims, characterised because the header has a signal adder (SM1) where the QAM signals generated by all the TDTs mix with the rest of QPSK signals not processed and, possibly, with the terrestrial television diffusion signals to form a multiplex of different kinds of signals.

5. System to increase the capacity of the satellite intermediate frequency signal distribution, according to second claim, characterised because the converter (CU1) has a filter FUHF, at whose auxiliary output SUHF1 the terrestrial diffusion analogue signals are available.

6. System to increase the capacity of the satellite intermediate frequency signal distribution networks, according to claim number two, characterised because the control microprocessor MP1 is governed in turn by the user receiver IRD1 through the communications port PRS232.

7. System to increase the capacity of the satellite intermediate frequency signal distribution networks, according to claim number six, characterised because the converter is controlled by the user receiver, preferably through a bus RS232, which determines both the input, the output frequency and the position of the signal source selection switch..

8. System to increase the capacity of the satellite intermediate frequency signal distribution networks, according to claim number four, characterised because the signals forming this multiplex are transported to the subscriber's home by means of a distribution network, which can be built around a coaxial cable, fibre optic or a combination of both.
